(19) United States
(12) Patent Application Publication
(10) Pub. No.: US 2002/0081361 A1
(43) Pub. Date: Jun. 27, 2002

(54) Drying of neotame with co-agents

(76) Inventors: Allan Towb, Buffalo Grove, IL (US); Aditi Dron, Streamwood, IL (US); Gale C. Walters, Vernon Hills, IL (US)

Correspondence Address: Jeffrey M. Hoster, The NutraSweet Company, Suite 3200, 10 S. Wacker Drive, Chicago, IL, 60606, US

(21) Appl. No.: 09/906,482

(22) Filed: Jul. 16, 2001

Related U.S. Application Data
(60) Provisional application No. 60/218,898, filed on Jul. 18, 2000.

(51) Int. Cl. A23L 1/236

(52) U.S. Cl. 426/548

(57) ABSTRACT

A novel product and process for producing neotame with co-agents is disclosed. Neotame is dried with agents such as maltodextrin to produce a product having desirable physical properties for products such as tabletop sweeteners and powdered soft drinks. By varying process conditions or ingredients, properties such as bulk density can be adjusted so that neotame can be delivered for such products. The resulting neotame products have surprising functionality in a variety of food, beverage, and other systems.

### BACKGROUND OF THE INVENTION

1. Field of the Invention

The field of the invention is sweeteners for addition to food products or sold as tabletop sweetener products. More particularly, the field of the invention relates to sweeteners co-dried with agents.

2. Description of the Prior Art

N-[N-(3,3-dimethylbutyl)-L-aspartyl-L-phenylalanine 1-methyl ester (hereinafter referred to as “Neotame”) is a highly intense non-nutritive sweetening agent useful to impart sweetness to a wide variety of food products, as well as other products which benefit from sweetening, including but not limited to oral care products, pharmaceutical products, and nutritional products such as nutraceuticals. This sweetener, disclosed in U.S. Pat. No. 5,480,668, is approximately 8,000 times as sweet as sucrose on a weight basis. Thus, very small quantities of the sweetening agent may be used to sweeten foods without adding calories, or to modify flavors and tastes when used at levels below sweetening threshold.

The potency of this sweetener adds to the challenges of delivering it in a form in which the sweetener is uniform in its distribution in the product which it is sweetening. This characteristic, known as content uniformity, is particularly important in products in which the neotame remains in dry form. Additionally, while neotame is not especially prone to dusting, in its powder form, it, like any powder, does produce a certain amount of dust. Given the potency, even loss of parts per million can impact the final cost of production of products incorporating neotame. An additional challenge results from neotame's use as a flavor and taste modifier as detailed in U.S. patent application Ser. No. 09/465,837, which is incorporated by reference herein. For these uses, neotame can be used at the part per billion level, so loss at even such a minute level can also impact the functionality of the neotame in such a product.

Additionally, certain type of ingredients are commonly added to products which also include high intensity sweeteners. For example, tabletop sweetener products sold in packets typically include bulking agents such as maltodextrin or dextrose with maltodextrin. Powdered soft drinks typically include such ingredients for bulking, as well as acids such as citric acid for taste. The effectiveness of means to deliver these ingredients is important in terms of cost and product consistency. This is especially important in flavor and taste modification uses as well.

Thus, means for delivering neotame with flexibility for use in a variety of food, beverage and similar systems would be especially desirable, given the challenges presented by the potency of neotame. Further, means for delivering neotame with very low levels of additives would also be desirable.

### SUMMARY OF THE INVENTION

Neotame may be prepared in a co-dried form with a series of co-agents. The drying method may include spray drying among other drying methods. The key element of the invention is that neotame can be tailored to a particular use by proper choice of co-agent, drying method, and other process conditions.

In particular, a tabletop sweetener product having spoon-for-spoon equivalence to table sugar can be produced under one of the inventive embodiments. This product is manufactured by first preparing a solution of neotame, maltodextrin and water. Carbon dioxide is then added to the solution, which is then sprayed through the spray dryer. The resulting product has bulk density and appearance which allows its substitution for table sugar, and enables one to match the sweetness level of such products.

Similarly, products which are effective for use in powdered soft drinks, confections, baked goods, and refrigerated and frozen foods can be manufactured by an inventive embodiment. Other co-agents may be used, and process conditions varied to produce neotame forms having desirable physical characteristics and functionality.

### DETAILED DESCRIPTION OF THE PREFERRED EMBODIMENT

The present invention entails the formation of particles of neotame dried with other agents. A series of preparation steps may be involved before such drying occurs.

In one embodiment, the neotame may be spray dried with one or more co-agents. The term co-agent as used herein shall include any ingredient which is desired to be used with, and is compatible with neotame for the product being produced. One skilled in the art will recognize that co-agents will be selected based on one or more functionalities which are desirable for use in the product applications for which the neotame product will be used. A broad range of ingredients are compatible with neotame, and can be selected for such functional properties.

The spray drying may be completed through conventional mixing in which solutions of the neotame and co-agent are formed. Alternatively, a suspension of neotame may be formed with co-agents. In an additional embodiment, the neotame may be vacuum drum dried with one or more co-agents. In additional embodiments, co-drying, high speed paddle drying and freeze-drying may be employed. Any drying equipment conventionally used for the drying of sweeteners or other products having similar physical properties can be used to conduct such drying.

The neotame used in such drying may be obtained directly from a process for making neotame, such as processes detailed in U.S. Pat. No. 5,510,508 or U.S. Pat. No. 5,728,862. The neotame used herein may also take other forms. For example, it may be a salt or complex such as described in U.S. patent application Ser. No. 09/146,963, U.S. patent application Ser. No. 09/146,964, U.S. patent application Ser. No. 09/148,134, U.S. patent application Ser. No. 09/146,965, and U.S. Provisional Patent Application No. 60/126,363, the disclosure of each of which is incorporated by reference herein. Other exemplary forms of neotame that may be used in this invention include co-crystallized forms and cyclodextrin complexes, such as described in U.S. patent application Ser. No. 09/154,568 and U.S. Provisional Patent Application No. 60/100,867, the disclosures of each of which are incorporated by reference herein. Agglomerates and other processed forms of neotame, and various forms of neotame crystallized using different processes also may be used, such as those described in U.S. patent application Ser. No. 09/252,072 and U.S. Provisional Patent Application No. 60/122,969, the disclosures of each of which are incorporated by reference herein.

In the first embodiment described above, a solution of neotame with the desired co-agent or co-agents, can be formed in 100% water. Such a solution will preferably include from about 0.001 to 15% by weight neotame, about 10 to 60% by weight co-agent and water to 100%. More preferably, such a solution will preferably include from about 0.01 to 2% by weight neotame, about 40 to 60% by weight co-agent and water to 100%. The specific levels at which neotame fully solubilizes will vary depending on the temperature and other process conditions.

Other solvents may be used to solubilize neotame. These solvents may be used as single solvents or in combinations with two or more solvents, including water. One of the surprising characteristics of neotame is its solubility with a wide range of potential solvents, including solvents which are not conventionally used with other high intensity sweeteners because of low solubility. A preferred solvent system is a 50:50 mixture by weight of water and ethanol. In such mixtures, the level of neotame included may be higher than the level in water alone, for example, a solution with 40% neotame and 60% of a 50:50 mixture of water and ethanol can be formed. Again, process conditions such as temperature will determine the specific limits of the solubilization of neotame.

Further, the amounts of neotame and co-agent, or the selection of other ingredients, may be adjusted in order to tailor the physical properties of the end product. For example, the desired bulk density of the resulting product may vary depending on the end product (e.g., a sweetener with co-agent to be added to powdered soft drinks) or product form (e.g., a tabletop sweetener product designed to be equivalent with table sugar in terms of amount of sweetness delivered per teaspoon, “Spoonful” form). The ingredients that can be used as co-agents include a wide range of products which can be used to provide bulk, or provide other functionalities. In selecting the co-agents, a key factor is ensuring that such co-agents can effectively be solubilized or suspended with neotame, and that they are compatible with neotame and do not have an adverse effect on the stability of the neotame.

Other physical properties of the product which can be controlled include particle size, shape, appearance, final moisture content, bulk density, and flowability.

The types of spray-drying equipment used can be selected from conventional spray drying equipment. The equipment can be tailored for specific product applications. For example, foam spray drying capability can be used to produce low bulk density products. If an instantized product is desired, a fluid bed can be attached to the spray dryer exit to produce a product with enhanced dissolution rates. An explosion proof spray dryer may be required if flammable solvents like ethanol are used in the feed solution. Other forms of spray dryers including, but are not limited to co-current nozzle tower spray dryers, co-current rotary atomizer spray dryers, counter-current nozzle tower spray dryers, and mixed-flow fountain nozzle spray dryers.

In one process, a table sugar substitute having the appearance and spoon-for-spoon equivalence of table sugar can be produced. Neotame and one or more co-agents selected from the group comprising hydrolyzed starch materials such as dextrins and sugars, starches, lactose, dextrose, maltodextrins, dextrose with maltodextrin, hydroxypropylmethylcellulose, edible organic acids, gum arabic, and other bulking agents and/or encapsulating agents are solubilized in water or alcohol/water mixtures. Additional sweeteners (either high intensity or sugar-based), flavoring agents, flavor modifiers and/or bulking agents can also be used as a co-agent, either alone or in combination with any of the above co-agents. A particularly preferred solvent is a water/ethanol mixture, due to the much higher solubility of neotame in such mixtures than in water alone.

The amount of neotame in a tabletop sweetener with spoon for spoon sweetness equivalence to sugar in a typical application (based on the final product composition after drying) will be about 0.01-1.0% neotame with the remaining ingredients being co-agents. For use as a sweetener ingredient, the neotame level can range from 0.01 to 50% (again based on the final product composition after drying) with the remaining ingredients being co-agents. However, due to the high potency of neotame as a sweetener, low levels of neotame would most likely be present in co-dried formulations to facilitate ease of use and content uniformity in the final product to which the neotame has been added.

In addition to the co-agents described above, other ingredients may be added in amounts effective for specific product benefits such as taste modification. In general, it is desired to have the amount of solids in the solution to be dried be in the range of between about 25-60%, preferably 40-60% by weight.

The solution is then preferably heated to a temperature of between about 40 to about 70° C. The specific temperature is selected on the basis of the dissolution properties of the dry ingredients and the desired viscosity of the spray drying feed solution as well as the co-agents used.

A non-reactive, non-flammable gas, for example, carbon dioxide, can be added to the solution before atomization in an amount effective to lower the bulk density of the resulting spray dried product and produce a product comprising hollow spheres.

The resulting solution is then fed through the spray dryer, preferably at an air inlet temperature of between about 150 to about 350° C. Increasing the inlet temperature at constant air flow may result in a product having reduced bulk density. The air outlet temperature should preferably be between 70 to about 140° C. If a high moisture product is desired, a lower outlet temperature can be used. Such a product can then be easily agglomerated in a fluid bed dryer to produce powders with superior dissolution. Such a fluid bed dryer can be connected to the outlet of the spray dryer

The resulting product has surprisingly low levels of degradant products, as no quantifiable differences could be seen between the degradant profile of the neotame starting material and the spray dried neotame. The product will typically have particle sizes between about 14 and 100 mesh, with the specific distribution varying depending on specific conditions and additives described above. A more preferred range is 16 to 80 mesh, but one skilled in the art will recognize that specific particle size cuts, including those with very narrow particle size distributions, can be obtained by use of screens which will retain or let pass the particles of the desired size.

The product which exits the spray dryer can be further treated or separated into cuts based on desired particle sizes. A desired particle size distribution can be obtained by using separation methods such as screening the spray dried product through screens of various sizes. For example, it may be desired to remove particles smaller than 80 mesh to improve flow properties of the resulting product. The largest particles may be removed to obtain a product having an especially good appearance as well as superior dissolution rates.

The product may be further treated to produce products of other forms. For example, low outlet temperature can be used to produce high moisture powder which can be agglomerated in a fluid bed, which can be connected to the discharge of the spray dryer to produce instant powders. The agglomeration can be carried out under conditions described in co-pending U.S. Application Ser. No. 09/252,072, filed Feb. 19, 1999 which is incorporated by reference herein. In addition, a fine powder could be produced by use of a high speed blender or pulverizer. The product can be dry blended with additional quantities of other sweeteners, including neotame, or bulking agents. The bulk density and flow properties of the product can be modified by dry blending a small amount of an anti-caking agent such as tricalcium phosphate.

A number of alternative processes may also be used to co-dry neotame with other ingredients. For example, vacuum drum drying, freeze drying, pan drying, or high speed paddle drying are among the co-drying processes which may produce products having specific desirable characteristics. Further, a process such as vacuum drum drying is especially desirable for co-drying with products containing nutrients to produce products such as nutraceuticals in which the nutrient content from the material co-dried with neotame can be preserved.

The processes described herein can handle different kinds of feed materials. Spray drying can handle only liquid feeds (slurries, solutions, and suspensions, for example) that can be atomized. Freeze drying and pan drying are very versatile and can handle the liquid feeds described above as well as wet cakes and pastes. Paddle dryers such as high speed paddle dryers can accept slurries, suspensions, gels and wet cakes. Vacuum drum drying methods are primarily used with liquid feeds, and have great flexibility in handling a wide range of viscosities.

An additional alternative process first requires the formation of a suspension including neotame. This suspension will contain neotame in an amount of from about 5 to about 75% by weight of the total weight of the suspension, more preferably 10 to about 50% by weight of the total weight of the suspension. An aqueous slurry including neotame is first formed. One or more water soluble flow agents such as food grade polymers, hydrocolloids, and/or gums are then added to the slurry to form a suspension. Suitable flow agents include, but are not limited to sodium carboxymethyl cellulose, algins including sodium alginate, calcium alginate, and propylene glycol alginate, gum arabic, xanthan gum, carrageenan, guar gum, hydroxypropyl methyl cellulose, gellan gum, methylcellulose, pectin, locust bean gum, caramel and mixtures thereof. Small amounts of emulsifier or wetting agent such as polysorbate (polyoxyethylene fatty acid ester) or lecithin may also be incorporated to improve the dissolution and stability characteristics of the suspension.

The flow agents will be incorporated in the suspension in an amount of from about 0.01 to about 5.0% by weight of the total weight of the suspension, more preferably 0.1 to about 2.0% by weight of the total weight of the suspension. The amount of flow agent is selected so that the resulting suspension has a viscosity such that it can be effectively dried, with said viscosity preferably in the range of 200 to 1000 m.Pa.

The suspension may be further mixed before spray drying with an aqueous solution of a water soluble encapsulation agent. This agent is preferably selected from the group consisting of maltodextrin, one or more starches such as hydrolyzed or modified corn starch, hydrolyzed or modified potato starch, gum arabic, and mixtures thereof. Upon spray drying, such agents are intended to encapsulate and protect the neotame and flow agent.

The product can be used directly as a tabletop sweetener, or can be used as an ingredient in food, beverage, pharmaceutical, nutraceutical, oral care and other products in which neotame or other sweeteners may be used. Examples of such products include chewing gum, baked goods, ice cream, yogurt, dry dessert mixes such as gelatins, puddings, powdered soft drinks, teas and coffees, and cake mixes. One particularly desirable use is for powdered soft drinks, in which the dried neotame product would be used in amounts ranging from 0.04 to 5.0%.

There are a number of surprising and unexpected benefits resulting from the use of various of the products, in particular spray dried products, as ingredients as described above. For example, delivery systems including neotame spray dried with maltodextrin have been found to improve overall sweet taste. In particular, in powdered soft drinks, powdered dessert mixes, and ice creams, these spray dried products have been found to make the sweetness of the product more consistent as well as decreasing the linger of sweetness and depressing the occurrence of licorice type cooling or flavor sometimes associated with neotame. These improvements can be optimized by identifying factors such as the order of addition of the ingredients. Further, the flow characteristics of a product can be modified by adding all ingredients together during the spray drying process.

The taste improvements resulting from the product of the present invention are especially surprising in that such improvements are seen as compared to equivalent mixtures of the same ingredients, with the only difference being the use of a spray dried product as opposed to a mixture.

The following examples are provided to more specifically describe several contemplated embodiments of the invention, but are not intended to limit the scope of the claimed invention. Examples 1-5 detail the preparation of dried products including neotame. Examples 6-8 detail the use of such co-dried products in final food formulations, and comparisons with food formulations containing the same ingredients but not produced by co-drying neotame with other ingredients.

### EXAMPLE 1

A solution was formed in a mixing tank with stirring and heating to around 65° C. The solution contained 53% maltodextrin, (Maltrin M100 brand, manufactured by Grain Processing Corporation, Muscatine, Iowa), 46.9% water and 0.1% neotame (manufactured by The NutraSweet Company, Chicago, Ill.). The solution was fed to an Anhydro spray dryer (manufactured by APV, Tonawanda, N.Y.). Carbon dioxide addition rate was adjusted in accordance with in-process bulk density measurements of powder. The solution was then fed through a Spraying Systems ¼N 1.5 nozzle spraying upward at a rate of approximately 25 kg/hr and an inlet temperature of 230° C. The resulting product had 0.10% neotame, 4.75% water, and a bulk density of 0.11 g/cc. The resulting product had the proper amount of neotame and the appearance of table sugar which would enable it to be used as a sugar substitute on a spoon for spoon equivalence basis with table sugar.

### EXAMPLE 2

909 g maltodextrin (Maltrin M100) was dissolved in 1091 g water in a Groen mixing tank. Water was heated to 54° C. before the addition of maltodextrin. After adding all the maltodextrin, the mixture was heated further to 65° C. while mixing continuosly to dissolve the maltodextrin completely. 1 g neotame powder was added to this maltodextrin solution and mixed using a Tekmar tissumizer at 65° C. The total solids of the solution were 46.2 brix. This feed solution was spray dried in a Portable Spray Dryer by Niro Inc. The inlet air temperature was in the range of 165-170° C. and the outlet air temperature was in the range 89-91° C. The air pressure to the rotary atomizer ranged from 40 to 60 psi. A fluffy white powder was obtained, having 0.10% neotame, and 5.87% water.

### EXAMPLE 3

L-Serine was added to this formulation as a flavor modifier. 909 g maltodextrin (Maltrin M100) was dissolved in 1091 g water in a Groen mixing tank with heating upto 65° C. 20 g L-Serine was added to this maltodextrin solution and mixed. After it was dissolved, 10 g Neotame powder was added to this solution and mixed. 100 g additional water was added to help the dissolution of the ingredients. The total solids of the solution were 44.6 brix. This feed solution was spray dried in a Portable Spray Dryer by Niro Inc. The inlet air temperatures were in the range of 165-175° C. and the outlet air temperatures were in the range 90-95° C. The air pressure to the rotary atomizer was 60 psi. A fluffy white powder was obtained, having 1.0% neotame, 3.63% water, and 2.2% serine.

### EXAMPLE 4

480 g Capsul starch (by National Starch and Chemical Company) was added to 1120 g water and mixed to form 1600 g of 30% starch solution. 33.5 g of a benzoic salt of Neotame was added to this starch solution and mixed for 15 minutes using an Ultra Turrax high shear mixer manufactured by IKA Corp. This slurry was stirred while it was fed to the spray dryer for drying. Portable spray dryer by Niro Inc. was used. The inlet air temperatures were in the range of 252-255° C. and the outlet air temperatures were in the range 112-117° C. The air pressure to the rotary atomizer was in the range 66-74 psi. An off-white powder was obtained containing 5.3% neotame and 4.6% water.

### EXAMPLE 5

A maltodextrin solution was made by dissolving 909 g maltodextrin (Maltrin M100) in 1091 g water in a Groen mixing tank with heating to 65° C. A gum solution was made separately by adding 1.25 gm sodium carboxymethylcellulose (type 7HF from Hercules) and 1.25 gm Keltrol HP from NutraSweet Kelco using a Tekmar tissumizer (high shear mixer) to 122.5 g water. The maltodextrin and gum solutions were mixed together and heated to 49° C. 90 g Neotame was added to this heated solution. The total solids of this suspension were 45.6 brix. Portable spray dryer by Niro Inc. was used. The inlet air temperatures were in the range of 168-170° C. and the outlet air temperatures were in the range 88-97° C. The air pressure to the rotary atomizer was in the range 40-50 psi. An off-white powder was obtained. The neotame content of the dried powder was 9.0% and the water content was 5.4%

### EXAMPLE 6

Neotame was added to a no-sugar ice cream mix in three different methods:

Sample 1: 20 ppm neotame was introduced in its powdered form at the flavor addition stage using a Lightnin'mixer to a pasteurized ice cream mix

Sample 2: Co-dried neotame/maltodextrin produced in Example 2 was added at 2%. Since the load of neotame in this delivery system was 0.10%, 20 ppm neotame was added to the system.

Sample 3: 20 ppm neotame was introduced in its powdered form. 1.998% 10 DE maltodextrin was added to equal the amount of maltodextrin added in Sample 2.

After addition of the neotame, the three samples were frozen in a Taylor soft serve freezer and the taste and flavor characteristics of the three samples were evaluated in bench screenings: Sample 2 was found to have a more even sweetness with less sweet linger, a more even vanilla flavor, and more dairy character than either Sample 1 or Sample 3.

### EXAMPLE 7

Neotame was added to a sugar free punch-flavored drink base in three different methods:

Sample 1: 14 ppm neotame was introduced in its powdered form

Sample 2: Co-dried neotamelmaltodextrin produced in Example 2 was added at 1.4%. Since the load of neotame in this delivery system was 0.10%, 14 ppm neotame was added to the system.

Sample 3: 14 ppm neotame was introduced in its powdered form. 1.3986% 10 DE maltodextrin was added to equal the amount of maltodextrin added in Sample 2.

The taste and flavor characteristics of the three samples were evaluated in bench screenings. Sample 2 was found to have more even sweetness with less sweet linger than either Sample 1 or Sample 3.

### EXAMPLE 8

Salt substitutes were prepared by physically mixing 50% NaCl with neotame and other ingredients as follows:

Sample 1: 49.986% 10 DE maltodextrin, 0.014% neotame powder

Sample 2: 36.000% 10 DE maltodextrin, 14.000% spray-dried maltodextrin/neotame delivery system (at 0.10% neotame load) to deliver 0.014% neotame

Sample 3: 49.993% 10 DE maltodextrin, 0.007% neotame powder

Sample 4: 43.000% 10 DE maltodextrin, 7.000% spray-dried maltodextrin/neotame delivery system (at 0.10% neotame load) to deliver 0.007% neotame

Each sample was mixed into mashed potatoes prepared according to recipe from Betty Crocker® instant potato mix. To 100 grams of prepared mashed potatoes, 0.50 grams of each sample was blended into the potatoes and mixed thoroughly.

The taste and flavor characteristics of the four samples were evaluated in bench screenings. Samples 1 and 2 were found to be slightly sweet. Samples 2 and 4 were found to have stronger potato flavor than Samples 1 and 3. The combination of the slight sweetness detection and stronger potato flavor in Sample 2 was found to be an acceptable product, but to match current potato flavor, Sample 4 was found to be the best choice.

What is claimed is:

1. A process for producing a product comprising neotame, comprising the step of drying neotame in the presence of a co-agent.

2. The process of claim 1 wherein said step of drying is selected from the group of drying methods comprising spray drying, vacuum drum drying, pan drying, and high speed paddle drying.

3. The process of claim 1 wherein said neotame is solubilized before, after or concurrent with the addition of said co-agent.

4. The process of claim 3 wherein said neotame is solubilized in water.

5. The process of claim 1 wherein said co-agent is selected from the group comprising bulking agents, encapsulating agents, and taste modification agents.

6. The process of claim 5 wherein said co-agent is selected from the group comprising hydrolyzed starch materials selected from the group of starch materials comprising dextrins and sugars, starches, lactose, dextrose, maltodextrin, dextrose with maltodextrin, edible organic acids, and gum arabic.

7. The process of claim 1 wherein a suspension of neotame and said co-agent is formed prior to said drying step.

8. A process for producing a product comprising neotame, comprising the step of spray drying neotame in the presence of a co-agent.

9. The process of claim 8 wherein said neotame is solubilized before, after or concurrent with the addition of said co-agent.

10. The process of claim 8 wherein said neotame is present in an amount of from about 0.01% to about 5% by weight based on the weight of said product.

11. The process of claim 8 further comprising the step of adding carbon dioxide to said solubilized neotame.

12. The process of claim 8 wherein said spray drying is conducted at an air inlet temperature of between about 150° C. and about 350° C.

13. The process of claim 8 wherein said spray drying is conducted at an air outlet temperature of between about 70° C. and about 140° C.

14. The process of claim 8 wherein said neotame is suspended with one or more flow agents selected from the group consisting of food grade polymers, hydrocolloids, and gums prior to said spray drying step.

15. The process of claim 14 wherein said flow agents are selected from the group consisting of sodium carboxymethyl cellulose, algins including sodium alginate, calcium alginate, and propylene glycol alginate, gum arabic, xanthan gum, carrageenan, guar gum, hydroxypropyl methyl cellulose, gellan gum, methylcellulose, pectin, locust bean gum, caramel and mixtures thereof.

16. The process of claim 14 further comprising the step of adding an encapsulating agent to said neotame suspended with said flow agent, wherein said encapsulating agent is selected from the group comprising maltodextrins, hydrolyzed corn starch, modified corn starch, hydrolyzed potato starch, modified potato starch, gum arabic and mixtures thereof.

17. The process of claim 14 wherein said neotame is present in an amount of from about 0.01% to about 5.0% by weight based on the weight of said product.

18. The process of claim 14 further comprising an emulsifier.

19. A co-dried product comprising neotame and one or more co-agents wherein said co-agent is selected from the group comprising hydrolyzed starch materials, starches, lactose, dextrose, maltodextrins, dextrose with maltodextrin, hydroxypropylmethylcellulose, edible organic acids, and gum arabic and other gums capable of solubilizing neotame.

20. The co-dried product of claim 19 wherein said product further comprises products selected from the group consisting of sweeteners and flavoring agents.

21. The co-dried product of claim 19 wherein said product has a bulk density in the range of from about 0.08 to about 1.5.

22. A tabletop sweetener product comprising the neotame product produced by claim 1, said tabletop sweetener product comprising neotame in an amount of between about 0.01 and about 50% by weight.

23. The tabletop sweetener product of claim 22 wherein said neotame product comprises a co-agent selected from the group consisting of hydrolyzed starch materials such as dextrins and sugars, starches, lactose, dextrose, maltodextrins, dextrose with maltodextrin, hydroxypropylmethylcellulose, edible organic acids, gum arabic, and other bulking agents.

24. The tabletop sweetener product of claim 22 wherein said neotame product further comprises one or more additional high intensity or sugar-based sweeteners, flavoring agents, or flavor modifiers.

25. The tabletop sweetener product of claim 22 wherein said tabletop sweetener has the appearance and spoon-for-spoon equivalence of sucrose.

26. A powdered soft drink product comprising the neotame product produced by claim 1, said powdered soft drink product comprising neotame in an amount of between about 0.04 and about 5.0% by weight.

27. The powdered soft drink product of claim 26 wherein said neotame product comprises a co-agent selected from the group consisting of hydrolyzed starch materials such as dextrins and sugars, starches, lactose, dextrose, maltodextrins, dextrose with maltodextrin, hydroxypropylmethylcellulose, edible organic acids, gum arabic, and other bulking agents.

28. The powdered soft drink product of claim 26 wherein said neotame product further comprises one or more additional high intensity or sugar-based sweeteners, flavoring agents, or flavor modifiers.

29. A salt product comprising: between about 10 and about 90% sodium chloride by weight; and a product comprising between about 0.01% and about 0.1% neotame and between about 10% and about 90% co-agent selected from the group consisting of hydrolyzed starch materials such as dextrins and sugars, starches, lactose, dextrose, maltodextrins, dextrose with maltodextrin, hydroxypropylmethylcellulose, edible organic acids, gum arabic, and other bulking agents, wherein said neotame and said co-agent are co-dried before being added to said sodium chloride.

30. The salt product of claim 29 wherein said co-agent is maltodextrin.

31. A process for enhancing the flavor profile of sweetened foods by sweetening such foods with neotame co-dried with a co-agent selected from the group comprising hydrolyzed starch materials such as dextrins and sugars, starches, lactose, dextroses, maltodextrins, dextrose with maltodextrin, hydroxypropylmethylcellulose, edible organic acids, gum arabic, and other bulking agents.

32. The process of claim 31 wherein said sweetened foods are selected from the group consisting of powdered soft drinks, tabletop sweeteners, chewing gum, baked goods, ice cream, yogurt, dry dessert mixes including but not limited to gelatins and puddings, powdered soft drinks, teas and coffees, and cake mixes.
